(19) United States
(12) Patent Application Publication
(10) Pub. No.: US 2009/0051243 A1
(43) Pub. Date: Feb. 26, 2009

(54) Micro actuator

(75) Inventors: Alex Horng, Kaohsiung City (TW); I-Yu Huang, Kaohsiung City (TW); Don-Liang Liu, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 11/902,218

(22) Filed: Sep. 20, 2007

(30) Foreign Application Priority Data
Aug. 22, 2007 (TW) 096131052

(51) Int. Cl. H02N 1/00

(52) U.S. Cl. 310/309

(57) ABSTRACT

The present invention relates to a micro actuator, which is located on a substrate and includes a plate and a bushing. A rear end of the plate exhibits a tapered triangular shape or an arc-like shape or has at least a bump disposed on a bottom surface of the rear end of the plate, making that a non-planar contact is present between the rear end of the plate and the substrate when both are contacted, so as to effectively reduce the friction and driving voltage and prolong the lifespan of components.

### FIELD OF THE INVENTION

The present invention relates to a micro actuator, which improves the disadvantages of short lifespan and high driving voltage of conventional micro actuator by reducing the contact area between the plate and substrate.

### BACKGROUND OF THE INVENTION

The structure of a micro fan includes two parts, namely, micro fan blades manufactured by self-assembly technique and a micro motor constituted by using a scratch drive actuator (SDA) or a bounce drive actuator (BDA) as a rotor.

Please refer to FIG. 1, which shows an example using a scratch drive actuator (SDA) to illustrate the actuation theory thereof:

The SDA is located on a substrate 12 and includes a plate 10 and a bushing 11;

When the plate 10 and the bushing 11 form a capacitive structure, an electrostatic force can be obtained on the plate 10. When a periodic electrostatic force is externally exerted on the plate 10, the plate 10 is enabled to generate a step motion on the substrate 12. As shown in FIG. 1(b), (c) and (d), the step motion between the plate 10 and the substrate 12 is illustrated while a square wave is applied externally.

When a positive bias voltage is applied externally, the plate 10 is attracted by the substrate 12 as a result of electrostatic force. Such phenomenon is called a snapping movement. Whereas, as the bushing 11 is present in front of the plate 10, the whole plate won't be fully attached on the substrate 12. Hence, charges will be temporarily stored on the plate 10, making that the plate 10 possesses elastic tension. When the positive bias voltage is increased up to a priming voltage, the plate 10 will result in greater deformation due to electrostatic force, and large area thereof will be in contact with the substrate 12.

When the voltage drops, the elastic tension is immediately released, making that the plate 10 recovers to its original form. Moreover, when releasing voltage, the plate 10 will be advanced because the bushing 11 is constantly contacted with the substrate 12.

When a negative bias voltage is further applied externally, the plate 10 will also be attracted by the substrate 12 to result in repeated movement, making that the plate 10 is continuously actuated on the substrate 12.

For sake of large-area friction between the plate 10 and the substrate 12 of a conventional micro actuator, the abrasion therebetween is relatively large, thus leading to a short lifespan, high driving voltage, large current consumption, and the existence of instant reversal phenomenon. Consequently, the reduction of contact area between the plate 10 and the substrate 12 is the key to less friction, lower driving voltage and longer lifespan of components.

### SUMMARY OF THE INVENTION

In view of the foregoing concern, the present invention thus provides a micro actuator capable of effectively reducing a contact area between a plate and a substrate thereof, in which the micro actuator is located on a substrate and includes a plate and a bushing.

A triangular shape or an arc-like shape is formed at a rear end of the plate, or at least a bump is disposed on a bottom surface of the rear end of the plate to exhibit a non-planar contact when the rear end of the plate is in contact with the substrate, so as to reduce friction and driving voltage and prolong lifespan of components.

### BRIEF DESCRIPTION OF THE DRAWINGS

FIG. 1 is a movement view of a conventional micro actuator;

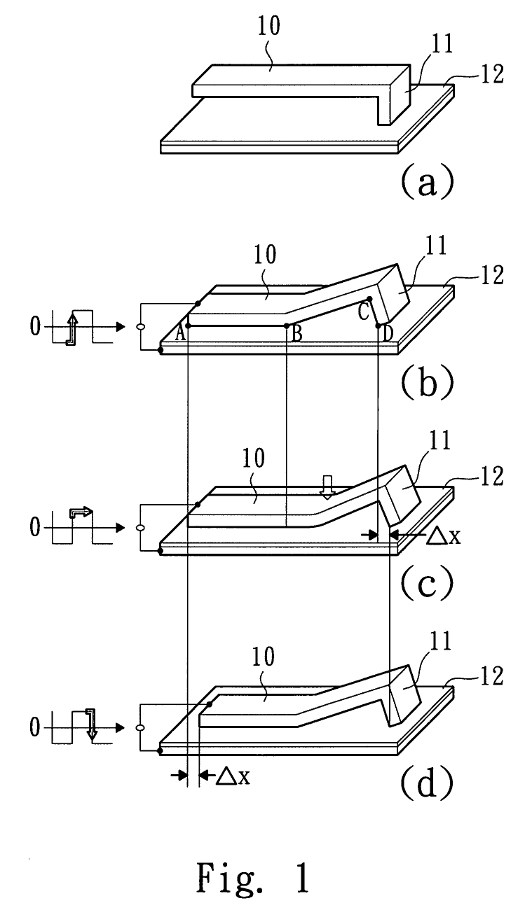

FIG. 2 is a movement view showing a first preferred embodiment of the present invention;

FIG. 3 is a movement view showing a second preferred embodiment of the present invention; and

FIG. 4 is a movement view showing a third preferred embodiment of the present invention.

### DETAILED DESCRIPTION OF THE PREFERRED EMBODIMENT

To make the object, features and efficacy of the present invention more comprehensive, preferred embodiments of the present invention are enumerated along with the detailed illustrative description.

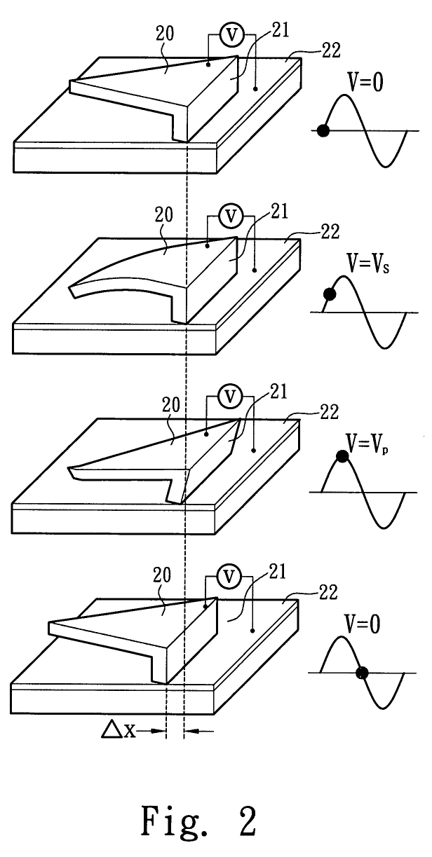

Please refer to FIG. 2. A micro actuator is located on a substrate 22 and includes a plate 20 and a bushing 21, wherein the plate 20 has a tapered triangular shape formed at a rear end of the plate 20.

When a positive bias voltage is applied externally, the plate 20 is attracted by the substrate 22 due to electrostatic force, so that an end point is contacted with the substrate 22. Meanwhile, as the friction, due to the contact of the plate 20 with the substrate 22, is less than the friction between the bushing 21 and the substrate 22, a significant small area of the rear end of the plate 20 is in contact with the substrate 22, further causing that the bushing 21 is extruded and shrunken and possesses an elastic tension.

As the plate 20 only has a non-planar contact with the substrate 22 and the plate 20 bends upwardly to alleviate the friction between the bushing 21 and the substrate 22 when it bounces back, adding that the rear end of the plate 20 of the micro actuator in the present invention forms a tapered triangular shape, a point contact is present between the rear end of the plate 20 and the substrate 22 when both are contacted, so as to effectively reduce the friction and driving voltage and prolong the lifespan of components.

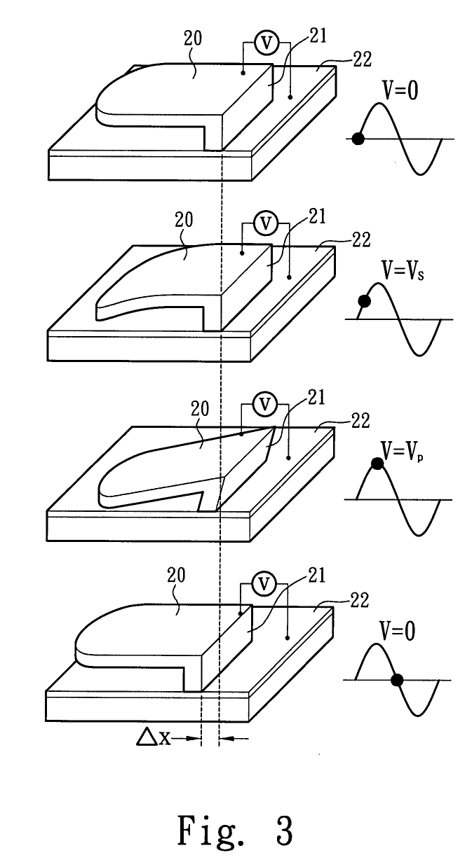

Please further refer to FIG. 3, which is a second preferred embodiment of the present invention. An arc-like shape is formed at the rear end of the plate 20. Therefore, when the rear end of the plate 20 is contacted with the substrate 22, likewise, a point contact is present therebetween, so as to effectively reduce the friction and driving voltage and prolong the lifespan of components.

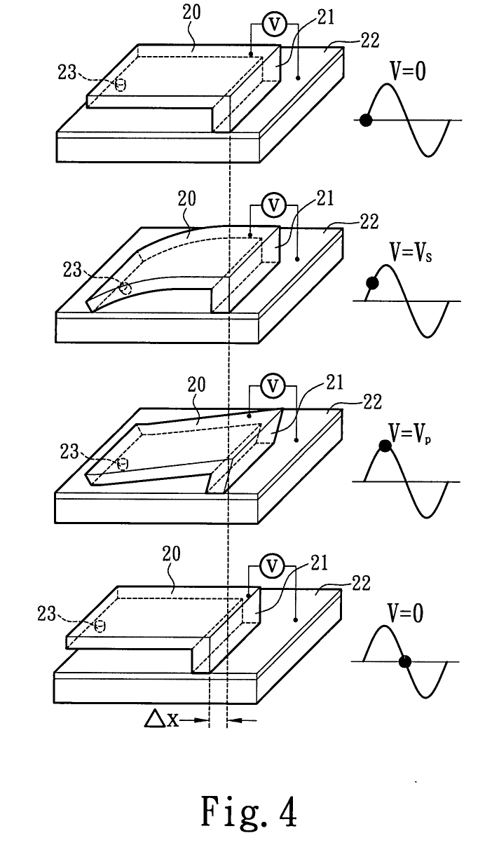

Please refer to FIG. 4, which is the third preferred embodiment of the present invention. The micro actuator is located on a substrate 22 and includes a plate 20 and a bushing 21, and a bottom surface of a rear end of the plate 20 has at least a bump 23.

By means of the design of the bump 23, when the rear end of the plate 20 is contacted with the substrate 22, a point contact is present therebetween, so as to reduce the friction and driving voltage and prolong the lifespan of components.

In sum, the present invention possesses the aforementioned advantages indeed. From the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A micro actuator located on a substrate, comprising:
a plate exhibiting a non-planar contact with said substrate when a rear end of said plate is in contact with said substrate; and
a bushing.

2. The micro actuator of claim 1, wherein a linear contact is present between said rear end of said plate and said substrate.

3. The micro actuator of claim 1, wherein a point contact is present between said rear end of said plate and said substrate.

4. The micro actuator of claim 1, wherein a tapered triangular shape is formed at said rear end of said plate.

5. The micro actuator of claim 1, wherein an arc-like shape is formed at said rear end of said plate.

6. The micro actuator of claim 1, wherein a bottom surface of said rear end of said plate has at least a bump.
